(19) United States
(12) Patent Application Publication
(10) Pub. No.: US 2024/0383487 A1
(43) Pub. Date: Nov. 21, 2024

(54) SYSTEMS FOR DETECTING ACTUATOR MISCONFIGURATIONS IN VEHICLES

(71) Applicant: GM GLOBAL TECHNOLOGY OPERATIONS LLC, Detroit, MI (US)

(72) Inventors: Sean Edward ZUZGA, Farmington Hills, MI (US); Samuel STEELE, Ypsilanti, MI (US); Edward Thomas HEIL, Howell, MI (US)

(21) Appl. No.: 18/317,184

(22) Filed: May 15, 2023

(51) Int. Cl. B60W 50/02; H04L 61/5038; H04L 61/5046

(52) U.S. Cl. CPC B60W 50/0205; H04L 61/5038; H04L 61/5046; B60W 2050/021; B60W 2050/022

(57) ABSTRACT

A system for detecting actuator misconfiguration in a vehicle includes actuators and a control module. Each actuator is assigned a unique identifier. The control module includes interface ports in communication with the actuators via serial data links. Each interface port is in communication with two of the actuators. Each actuator is in communication with two of the interface ports. The control module is configured to receive a message from an actuator installed at a location of the vehicle, the message including the unique identifier assigned to the actuator, compare the received unique identifier assigned to the actuator to a stored identifier specific to the location of the vehicle, and in response to the received unique identifier being different than the stored identifier, transmit an error signal indicating a failure associated with the actuator. Other examples systems and methods for detecting actuator misconfiguration in vehicles are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems for detecting actuator misconfigurations in vehicles.

Vehicles often include actuators for facilitating physical movement of vehicle components. Such actuators may be controlled by signals from a control module, such as a centralized supervisory control module. For example, a vehicle braking system may include a control module for controlling brake actuators located at each of the four corners of the vehicle. This vehicle braking system is sometimes referred to as a brake-by-wire system. In other examples, actuators may be located near and/or employed with vehicle doors, steering systems, propulsion systems, etc.

### SUMMARY

A system is disclosed for detecting actuator misconfiguration in a vehicle. The system includes a plurality of actuators and a control module. Each actuator of the plurality of actuators is assigned a unique identifier. The control module includes a plurality of interface ports in communication with the plurality of actuators via serial data links. Each interface port of the control module is in communication with two of the plurality of actuators. Each actuator of the plurality of actuators is in communication with two of the interface ports. The control module is configured to receive a message from an actuator of the plurality of actuators installed at a location of the vehicle, the message including the unique identifier assigned to the actuator, compare the received unique identifier assigned to the actuator to a stored identifier specific to the location of the vehicle, and in response to the received unique identifier being different than the stored identifier, transmit an error signal indicating a failure associated with the actuator.

In other features, the control module is configured to identify a reason for the failure based on the received unique identifier and the stored identifier and transmit the error signal with the reason for the failure.

In other features, the plurality of interface ports of the control module includes four interface ports, and the plurality of actuators includes four actuators.

In other features, each actuator of the plurality of actuators includes a first interface port in communication with one of the four interface ports and a second interface port in communication with another one of the four interface ports.

In other features, the four actuators include a first actuator installed at a front, left location of the vehicle, a second actuator installed at a front, right location of the vehicle, a third actuator installed at a rear, left location of the vehicle, and a fourth actuator installed at a rear, right location of the vehicle. The four interface ports include a first interface port in communication with the first actuator and the fourth actuator, a second interface port in communication with the second actuator and the third actuator, a third interface port in communication with the third actuator and the fourth actuator, and a fourth interface port in communication with the first actuator and the second actuator.

In other features, the four actuators are brake actuators.

In other features, each brake actuator of the brake actuators includes a memory module configured to store, before the brake actuator is installed in the vehicle, information about the brake actuator and an expected location of the brake actuator in the vehicle.

In other features, the serial data links include of ethernet links.

In other features, the unique identifier assigned to each actuator is a predefined MAC address stored in a memory module associated with the actuator.

A system is disclosed for detecting actuator misconfiguration in a vehicle. The system includes a plurality of actuators and a control module. Each actuator of the plurality of actuators assigned a unique identifier. The control module includes a first aggregator module and a second aggregator module. The first aggregator module includes a plurality of interface ports. Each interface port of the first aggregator module is in communication with two different actuators of the plurality of actuators via a serial data link. The second aggregator module includes a plurality of interface ports. Each interface port of the second aggregator module is in communication with two different actuators of the plurality of actuators via a serial data link. The control module is configured to receive, via the first aggregator module or the second aggregator module, a message from an actuator of the plurality of actuators installed at a location of the vehicle, the message including the unique identifier assigned to the actuator, compare the received unique identifier assigned to the actuator to a stored identifier specific to the location of the vehicle, and in response to the received unique identifier being different than the stored identifier, transmit an error signal indicating a failure associated with the actuator.

In other features, the control module is configured to identify a reason for the failure based on the received unique identifier and the stored identifier and transmit the error signal with the reason for the failure.

In other features, the plurality of interface ports of the first aggregator module includes two interface ports, the plurality of interface ports of the second aggregator module includes two interface ports, and the plurality of actuators includes four actuators.

In other features, each actuator of the plurality of actuators includes a first interface port in communication with one of the two interface ports of the first aggregator module and a second interface port in communication with one of the two interface ports of the second aggregator module.

In other features, the four actuators include a first actuator located in a front, left position of the vehicle, a second actuator located in a front, right position of the vehicle, a third actuator located in a rear, left position of the vehicle, and a fourth actuator located in a rear, right position of the vehicle. The two interface ports of the first aggregator module include a first interface port in communication with the first actuator and the fourth actuator, and a second interface port in communication with the second actuator and the third actuator. The two interface ports of the second aggregator module include a first interface port in communication with the third actuator and the fourth actuator, and a second interface port in communication with the first actuator and the second actuator.

In other features, the four actuators are brake actuators.

In other features, each brake actuator of the brake actuators includes a memory module configured to store, before the brake actuator is installed in the vehicle, information about the brake actuator and an expected location of the brake actuator in the vehicle.

In other features, the serial data link includes of an ethernet link.

In other features, the unique identifier assigned to each actuator is a predefined MAC address stored in a memory module associated with the actuator.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example actuator misconfiguration detection system including a control module and four actuators according to the present disclosure;

FIG. 2 is a block diagram of another example actuator misconfiguration detection system including two aggregator modules according to the present disclosure;

FIG. 3 is a block diagram of another example actuator misconfiguration detection system where the actuators are brake actuators for a vehicle according to the present disclosure;

FIG. 4 is a diagram of a vehicle including the system of FIG. 3 according to the present disclosure;

FIG. 5 is a block diagram of an example actuator misconfiguration detection system with two actuators switched according to the present disclosure;

FIG. 6 is a block diagram of an example actuator misconfiguration detection system with two actuators experiencing a loss of communication according to the present disclosure;

FIG. 7 is a block diagram of an example actuator misconfiguration detection system with one actuator experiencing a loss of power according to the present disclosure;

FIG. 8 is a block diagram of an example actuator misconfiguration detection system with one actuator being incorrectly installed according to the present disclosure; and

FIG. 9 is a flowchart of an example control process for detecting an actuator misconfiguration in a vehicle according to the present disclosure.

In the drawings, reference numbers may be reused to identify similar and/or identical elements.

### DETAILED DESCRIPTION

Vehicles often include controllable actuators for moving vehicle components. Sometimes, actuators associated with similar components in a vehicle are manufactured to have a commonality of hardware components. For example, brake actuators employed with a vehicle braking system and located at different corners of the vehicle may each have the same (or similar) hardware components. While commonality of hardware components may reduce manufacturing and installation costs, time, etc., such benefits may be overshadowed by vehicle level hazards associated with this commonality. For example, the commonality of hardware components drives the possibility that at least one of the actuators could be mechanically installed at an incorrect location (e.g., corner, etc.) of the vehicle, which would cause a vehicle level hazard. For instance, if a corner brake actuator is configured incorrectly (e.g., a left actuator is installed on right side, etc.), a vehicle level hazard may arise when a control module attempts to control the brake actuator. In such scenarios, the control module may intend to send a control signal to the corner brake actuator which the control module believes is installed on left side, but instead sends (unknowingly) the control signal to another corner brake actuator (e.g., installed on the right side). Similar concerns may exist with actuators employed with vehicle doors, steering systems, propulsion systems, and/or other safety critical features in vehicles.

The systems and methods according to the present disclosure provide accurate verification and detection of hardware installation positions of actuators and their corresponding software by leveraging automotive communication networks and unique communication connections between the actuators and one or more control modules. For example, the systems and methods herein may include multiple actuators each assigned a unique identifier and at least one control module including interface ports in communication with the actuators via serial data links. In such examples, each interface port is in communication with two actuators, and each actuator is in communication with two interface ports. With this unique configuration, the control module may receive, from one of the actuators installed at a location of the vehicle, a message including its unique identifier, compare the received unique identifier assigned to the actuator to a stored identifier specific to the location of the vehicle, and then transmit an error signal indicating a failure associated with the actuator in response to the received unique identifier being different than the stored identifier. As such, due to the unique configurations of communication networks to each actuator along with the control module being able to identify the physical location of each actuator based on which communication network the actuator communicates on, the control module may recognize if one of the actuators is incorrectly located in the vehicle and/or otherwise misconfigured, and then set a system failure. As such, misconfiguration of actuators in a vehicle may be detected during manufacturing of the vehicle and corrected, thereby preventing possible safety critical events (e.g., actuate the wrong brake, door, etc.) from occurring when, for example, the vehicle is operated.

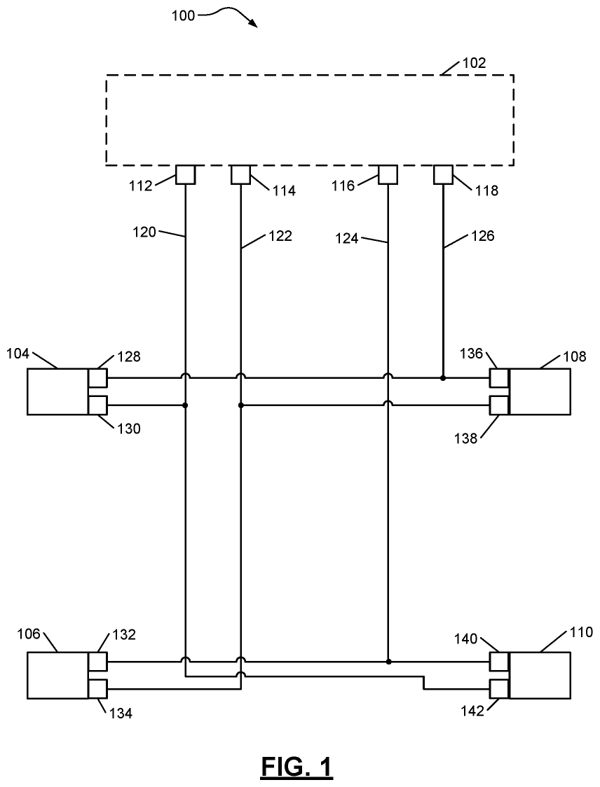

Referring now to FIG. 1, a block diagram of an example system 100 is presented for detecting an actuator misconfiguration in a vehicle. The system 100 of FIG. 1 may be employable in any suitable vehicle, such as an electric vehicle (e.g., a pure electric vehicle, a plug-in hybrid electric vehicle, etc.), an internal combustion engine vehicle, etc. Additionally, the system 100 may be applicable to an autonomous vehicle, a semi-autonomous vehicle, or a non-autonomous vehicle.

As shown in FIG. 1, the system 100 generally includes a control module 102 and four actuators 104, 106, 108, 110 in communication with the control module 102. Specifically, the control module 102 includes four interface ports 112, 114, 116, 118 in communication with the actuators 104, 106, 108, 110 via serial data links 120, 122, 124, 126. In the example of FIG. 1, each actuator 104, 106, 108, 110 includes two interface ports. Specifically, and as shown in FIG. 1, the actuator 104 includes interface ports 128, 130, the actuator 106 includes interface ports 132, 134, the actuator 108 includes interface ports 136, 138, and the actuator 110 includes interface ports 140, 142. Although the system 100 of FIG. 1 is shown and described as including four actuators and four control module interface ports, it should be appreciated that the system 100 may include more or less actuators and/or control module interface ports if desired. For example, the system 100 may include two actuators, three actuators, five actuators, six actuators, etc. and/or two interface ports, three interface ports, five interface ports, six interface ports, etc.

In the example of FIG. 1, each interface port 112, 114, 116, 118 of the control module 102 is in communication with two of the actuators 104, 106, 108, 110. For example, the interface port 112 is connected with the actuators 104, 110 via the serial datal link 120, and the interface port 114 is connected with the actuators 106, 108 via the serial datal link 122. Further, the interface port 116 is connected with the actuators 106, 110 via the serial datal link 124, and the interface port 118 is connected with the actuators 104, 108 via the serial datal link 126. While the interface ports 112, 114, 116, 118 are shown and described as being connected to specific actuators, it should be appreciated that the system 100 may include a different control module interface port to actuator configuration so long as each interface port is in communication with a different set of two actuators.

Additionally, and as shown in FIG. 1, each actuator 104, 106, 108, 110 is in communication with two of the interface ports 112, 114, 116, 118. For instance, the interface ports 128, 130 of the actuator 104 are connected to the interface ports 118, 112, respectively, of the control module 102. Likewise, the interface ports 132, 134 of the actuator 106 are connected to the interface ports 116, 114 (respectively), the interface ports 136, 138 of the actuator 108 are connected to the interface ports 118, 114 (respectively), and the interface ports 140, 142 of the actuator 110 are connected to the interface ports 116, 112 (respectively). While the interface ports of the actuators 104, 106, 108, 110 are shown and described as being connected to specific interface ports of the control module 102, it should be appreciated that the system 100 may include a different actuator interface port to control module configuration so long as each actuator is in communication with a different set of two interface ports of the control module 102.

In the system 100 of FIG. 1, the interface ports of the control module 102 and the actuators 104, 106, 108, 110 may be any suitable type of serial interface connector. For example, the interface ports may be serial ports with multiple pins, multiple receptables, etc. In such examples, the serial data links 120, 122, 124, 126 may be wired networks. In other examples, the interface ports of the control module 102 and the actuators 104, 106, 108, 110 may form wireless connection points with antennas and receivers.

The serial data links 120, 122, 124, 126 of FIG. 1 may be any suitable serial communication network. For example, each serial data link 120, 122, 124, 126 may be an ethernet link (e.g., a wired or wireless network) or another suitable serial communication network. In various embodiments, each serial data link 120, 122, 124, 126 may form a 10BASE-T1S network including the control module 102 (with its specific interface port) and the two connected actuators. In such examples, each 10BASE-T1S network may employ ethernet networking techniques that uses twisted-pair cables to transmit data at a rate of 10 megabits per second. With this configuration, each 10BASE-T1S network relies on a half-duplex transmission such that only one module (e.g., the control module 102 or one of the connected actuators) may transmit data (e.g., in the form of a message) at a time. For instance, each module of each 10BASE-T1S network may be given an opportunity to transmit data in a round robin fashion.

In the example of FIG. 1, each actuator 104, 106, 108, 110 is assigned one or more unique identifiers. Further, in some examples, each interface port of each actuator 104, 106, 108, 110 may be assigned one or more unique identifiers. For instance, the unique identifier(s) for a particular actuator 104, 106, 108, 110 may be based on a defined vehicle location for the actuator. For example, the actuator 104 may be designated a front, left actuator (e.g., intended to be installed at a front, left location of the vehicle), the actuator 106 may be designated a rear, left actuator, the actuator 108 may be designated a front, right actuator, and the actuator 110 may be designated a rear, right actuator. In such examples, the unique identifier(s) assigned to the particular actuator based on the designated vehicle location may be stored in a memory module (not shown in FIG. 1) associated with that actuator. For example, software instructions stored in the memory module may be flashed to include the unique identifier(s) during manufacturing of the actuator. In such examples, the unique identifier(s) may override (e.g., mask) existing identifiers of the actuator.

In various embodiments, the unique identifiers for the actuators 104, 106, 108, 110 may include any suitable type of identifying reference. For example, the unique identifiers may include media access control (MAC) addresses, internet protocol (IP) addresses, scalable service-oriented middleware over IP (SOME/IP) addresses, etc. In one non-limiting example, the interface port 128 of the actuator 104 may be assigned a MAC address of AA, the interface port 130 of the actuator 104 may be assigned a MAC address of EE, the interface port 136 of the actuator 108 may be assigned a MAC address of BB, and the interface port 138 of the actuator 108 may be assigned a MAC address of FF. Likewise, the interface ports of the remaining actuators 106, 110 may be assigned other MAC addresses. Thus, during manufacturing of the actuators 104, 108, software instructions associated with the actuator 104 may be flashed to include the unique MAC addresses AA, EE and software instructions associated with the actuator 108 may be flashed to include the unique MAC addresses BB, FF.

Additionally, in the example of FIG. 1, the control module 102 is operable to receive and store identifiers specific to locations of the vehicle. For example, the control module 102 may store identifiers AA, EE for ports of an actuator designated as a front, left actuator, and identifiers BB, FF for ports of an actuator designated as a front, right actuator. Further, the control module 102 may store or link associated ports 112, 114, 116, 118 thereof with the designated actuators. For instance, the control module 102 may link the identifiers AA, EE of the front, left actuator with the interface ports 118, 112 (respectively), and link the identifiers BB, FF of the front, right actuator with the interface ports 118, 114 (respectively). As such, with the configuration of the stored identifiers and linked interface ports, the control module 102 knows what actuators should be positioned at specific locations of the vehicle and what identifiers should be received from the locations.

The control module 102 is also operable to know what actuators are actually installed at specific locations of the vehicle. For example, the control module 102 receives messages from the actuators 104, 106, 108, 110 installed at different locations of the vehicle. In such examples, each message includes the unique identifier assigned to the transmitting actuator. For instance, in the link 126 (e.g., a network), the control module 102 may receive (at the interface port 118) a message including the unique identifier AA from the interface port 128 of the actuator 104 and the unique identifier BB from the interface port 136 of the actuator 108.

Then, the control module 102 may compare the received unique identifiers assigned to the actuators 104, 106, 108, 110 to the stored identifiers specific to the locations of the vehicle. For example, after the control module 102 receives (at the interface port 118) the unique identifier AA from the interface port 128 of the actuator 104 and the unique identifier BB from the interface port 136 of the actuator 108, the control module 102 may retrieve stored identifiers linked to the interface port 118. In such examples, the control module 102 may retrieve the stored identifiers AA, BB. The control module 102 may then compare each stored identifier AA, BB with each received unique identifier AA, BB. If the stored and received identifiers match, no action may be taken by the control module 102.

However, if the stored and received identifiers are different, the control module 102 may generate and transmit an error signal indicating a failure associated with one or more of the actuators 104, 106, 108, 110. For example, the control module 102 transmit the error signal to a device, such as a display device, to notify technicians that the actuator(s) are misconfigured. In response, the technicians may correct the misconfigured actuator(s).

Additionally, the control module 102 may identify a reason for the failure. For example, because the control module 102 is operable to know what actuators should be positioned at specific locations of the vehicle and what identifiers should be received from the locations, the control module 102 may identify if particular actuators are switched (e.g., the front, left actuator and the front, right actuator are switched), if a particular actuator is in a wrong location, if a particular actuator is programmed with the incorrect identifiers, etc. as further explained below. Then, the control module 102 may generate and transmit the error signal with the reason for the failure if desired.

In various embodiments, the control module 102 of FIG. 1 may include and/or be in communication with multiple modules for communicating with, receiving data from, etc. the actuators 104, 106, 108, 110. For example, in some embodiments, the control module 102 may include and/or be in communication with multiple aggregator modules each having a different set of the interface ports 112, 114, 116, 118 of FIG. 1. In such examples, each aggregator module may be a networking component that allows multiple network connections to be bundled into a single link. With this configuration, possible redundancy requirements for single point failures in the system may be satisfied.

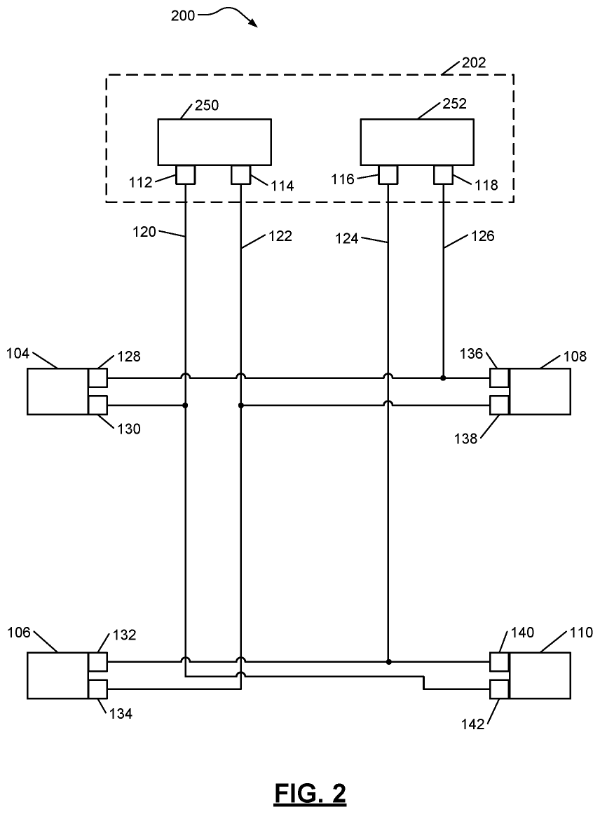

For example, FIG. 2 depicts another system 200 for detecting an actuator misconfiguration in a vehicle. The system 200 is substantially similar to the system 100 of FIG. 1, but includes two aggregator modules 250, 252. Specifically, the system 200 includes a control module 202 having the aggregator modules 250, 252, and the actuators 104, 106, 108, 110 of FIG. 1. As shown, the aggregator module 250 includes the interface port 112 connected to the actuators 104, 110 (via the serial data link 120 and the interface ports 130, 142) and the interface port 114 connected to the actuators 106, 108 (via the serial data link 122 and the interface ports 134, 138). Additionally, the aggregator module 252 includes the interface port 116 connected to the actuators 106, 110 (via the serial data link 124 and the interface ports 132, 140) and the interface port 118 connected to the actuators 104, 108 (via the serial data link 126 and the interface ports 128, 136).

In the example of FIG. 2, the control module 202 may function in a similar manner as the control module 102 of FIG. 1. For instance, the control module 202 may receive, via the aggregator modules 250, 252, messages including the unique assigned identifiers from the actuators 104, 106, 108, 110 installed at locations of the vehicle, compare the received unique identifiers to stored identifiers specific to the locations of the vehicle, and then generate and transmit an error signal indicating a failure associated with one or more the actuators 104, 106, 108, 110 (and in some embodiments, an identified reason for the failure) if the compared identifiers are different, as explained herein.

Although the system 200 of FIG. 2 depicts the aggregator modules 250, 252 as being internal to the control module 202, it should be appreciated that other suitable configurations may be employed if desired. For example, the aggregator modules 250, 252 may be components separate from (e.g., external to) the control module 202, but in communication with the control module 202. In other examples, the aggregator modules 250, 252 each may be considered a control module and operable as the control module 102 of FIG. 1.

As explained herein, the actuators 104, 106, 108, 110 may be employed with various different vehicle features. For example, the actuators 104, 106, 108, 110 may be actuators employed with a vehicle braking system, with vehicle doors, with a vehicle steering system, with a vehicle propulsion system, and/or any other suitable vehicle feature.

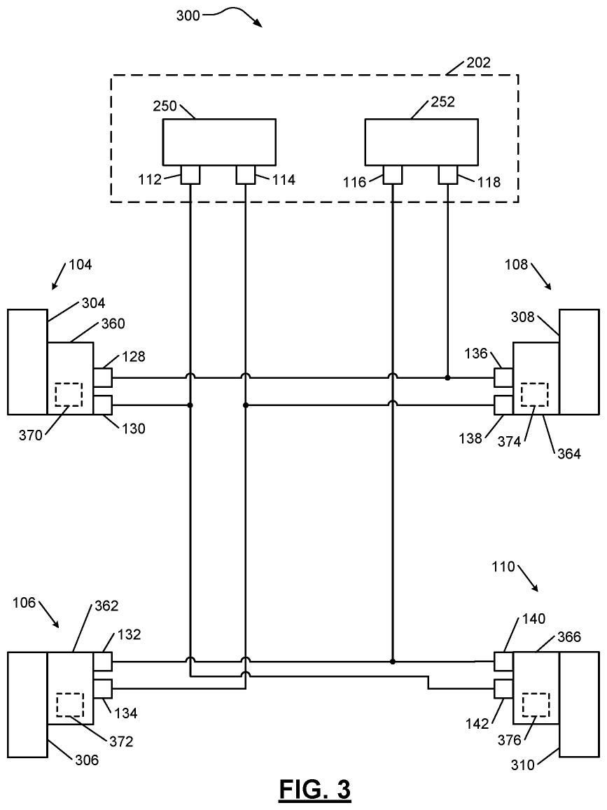

FIG. 3 depicts another system 300 for detecting an actuator misconfiguration in a vehicle, where the system 300 includes actuators employed in a vehicle braking system. As shown, the system 300 includes the control module 202 of FIG. 2 and the actuators 104, 106, 108, 110 of FIG. 1 in communication with the control module 202 via the unique configurations of communication networks as explained herein.

In the example of FIG. 3, the actuators 104, 106, 108, 110 may be any suitable type of brake actuators for the vehicle. For example, the actuators 104, 108 may be considered front brake actuators and installed at front, left and front, right locations (respectively) of the vehicle. The actuators 106, 110 may be considered rear brake actuators and installed at rear, left and rear, right locations (respectively) of the vehicle. In various embodiments, the front actuators 104, 108 may be electro-hydraulic actuators for brakes associated with the vehicle's front wheels and the rear actuators 106, 110 may be electro-mechanical actuators for brakes associated with the vehicle's rear wheels. In such examples, each actuator 104, 106, 108, 110 may include various components 304, 306, 308, 310, such as an electric motor, valves, etc.

As shown in FIG. 3, the actuators 104, 106, 108, 110 also include control modules 360, 362, 364, 366 and memory modules 370, 372, 374, 376 associated with the control modules 360, 362, 364, 366. For example, the memory modules 370, 372, 374, 376 may be components within the control modules 360, 362, 364, 366 (as shown in FIG. 3) and/or external to (but in communication with) the control modules 360, 362, 364, 366.

In various embodiments, the memory modules 370, 372, 374, 376 associated with the control modules 360, 362, 364, 366 may store desired information. For example, the memory modules 370, 372, 374, 376 may store unique identifiers, such as MAC addresses, etc. as explained above. In such examples, the memory modules 370, 372, 374, 376 may be flashed to include the unique identifiers during manufacturing of the actuators 104, 106, 108, 110.

Additionally, in some examples, the memory modules 370, 372, 374, 376 may store information about the actuators 104, 106, 108, 110 and an expected location of the actuators 104, 106, 108, 110 in the vehicle. In various embodiments, the information and location of the actuators 104, 106, 108, 110 may be stored when the actuators 104, 106, 108, 110 are originally manufactured. The information about the actuators 104, 106, 108, 110 may include, for example, an actuator size (e.g., a torque value), the type of actuator (e.g., hydraulic, electro-hydraulic, electro-mechanical, etc.), etc. Additionally, the expected location of the actuators 104, 106, 108, 110 may include, for example, left front, right front, left rear, right rear, etc.

Additionally, in the example of FIG. 3, the control modules 360, 362, 364, 366 include interface ports for communicating with the aggregator modules 250, 252. Specifically, the control module 360 includes the interface ports 128, 130 of FIG. 1, the control module 362 includes the interface ports 132, 134 of FIG. 1, the control module 364 includes the interface ports 136, 138 of FIG. 1, and the control module 366 includes the interface ports 140, 142 of FIG. 1. In such examples, the interface ports 128, 130, 132, 134, 136, 138, 140, 142 are in communication with the interface ports 112, 114, 116, 118 of the aggregator modules 250, 252 as explained above.

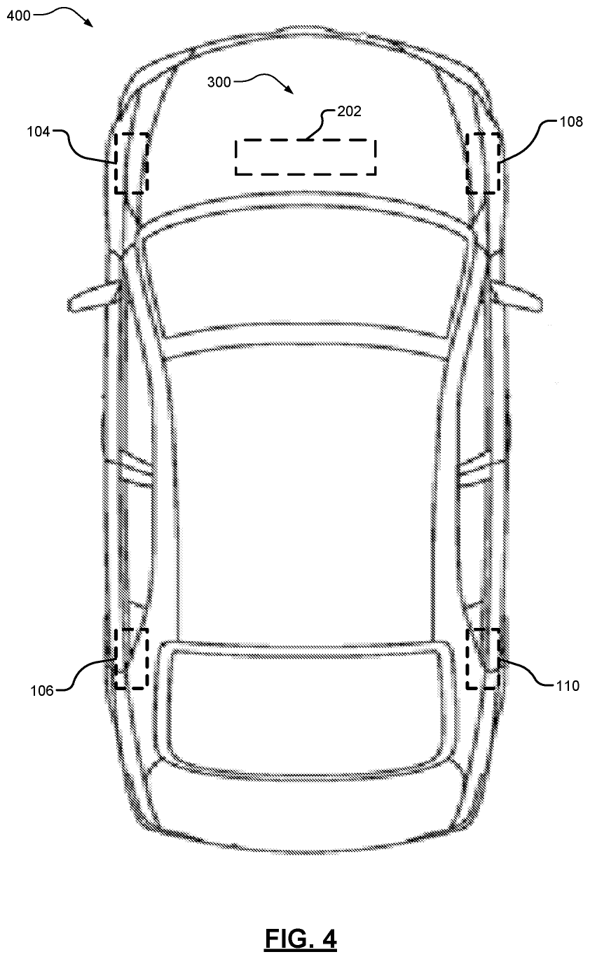

In various embodiments, any one of the actuator misconfiguration detection systems herein and/or components thereof may be employed in a vehicle. For example, FIG. 4 depicts a vehicle 400 including the system 300 of FIG. 3. Specifically, and as shown in FIG. 4, the vehicle 400 includes the control module 202 and the actuators 104, 106, 108, 110 of FIG. 3. As shown, the actuators 104, 108 are located at front, left and right locations (respectively) of the vehicle 400, and the actuators 106, 110 are located at rear, left and right locations (respectively) of the vehicle. Although the vehicle 400 of FIG. 4 is shown as including the system 300, it should be appreciated that the vehicle 400 may include another actuator misconfiguration detection system, such as one of the systems 100, 200. Further, although the actuators 104, 106, 108, 110 of FIG. 4 are shown as brake actuators, it should be appreciated that the actuators 104, 106, 108, 110 may be employed with other vehicle features, such as vehicle doors, a vehicle steering system, a vehicle propulsion system, etc.

In various embodiments, the control modules herein may recognize one or more actuator misconfigurations in vehicles as explained herein. For example, the control modules 102, 202 of FIGS. 1-3 may be preconfigured to know what actuators should be positioned at specific locations of the vehicle (and therefore connected to particular interface ports of the control module) and what identifiers should be received from the locations. Thus, when the actuators are installed at specific locations of the vehicle and then transmit their unique identifiers to the control module, the control module is able to compare its stored (preconfigured) identifiers with the received unique identifiers to detect an actuator misconfiguration (e.g., a system failure) and identify a reason for the system failure.

For example, the control module 202 may detect and identify a software misconfiguration specific to any one of the installed actuators 104, 106, 108, 110. For instance, the actuators 104, 106, 108, 110 may include defined software identifications (SW IDs) stored therein and known by the control module 202. The SW ID for each actuator 104, 106, 108, 110 is different due to different software instructions (e.g., with different MAC addresses) employed by the actuator. When communicating with the control module 202, the actuators 104, 106, 108, 110 may provide their SW IDs along with other data about the actuators. If the received SW ID for one of the actuators 104, 106, 108, 110 is unexpected (e.g., not the correct SW ID for the installed location in the vehicle), the control module 202 may identify the software misconfiguration for the particular actuator as the reason for a system failure.

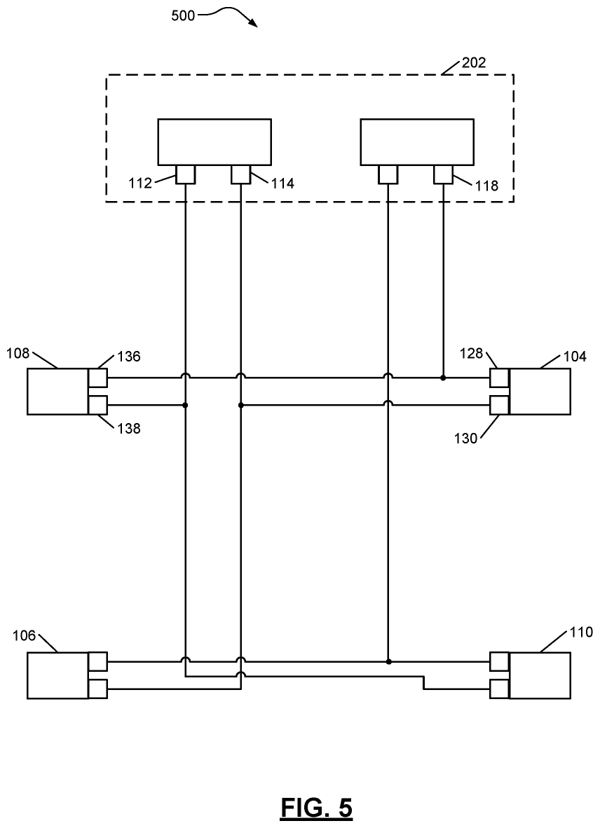

In other examples, the control module 202 may detect and identify a hardware and/or physical misconfiguration specific to any one of the installed actuators 104, 106, 108, 110. For example, FIG. 5 depicts a system 500 substantially similar to the system 200 of FIG. 2, but with the actuators 104, 108 switched. In such examples, the control module 202 expects to receive unique identifiers (e.g., the MAC addresses AA, EE) for the interface ports 128, 130 of the actuator 104 on the interface ports 118, 112, respectively, and unique identifiers (e.g., the MAC addresses BB, FF) for the interface ports 136, 138 of the actuator 108 on the interface ports 118, 114, respectively. However, when the actuators 104, 108 are switched, the control module 202 actual receives the unique identifier (e.g., the MAC address EE) for the interface port 130 of the actuator 104 on the interface port 114, and the unique identifier (e.g., the MAC address FF) for the interface port 138 of the actuator 108 on the interface port 112. As such, when the control module 202 compares the received unique identifiers with its stored identifiers, the control module 202 is able to recognize that the actuators 104, 108 are switched.

Additionally, the control module 202 may detect and identify misconfigurations when other sets of the actuators 104, 106, 108, 110 are switched in a similar manner as explained above. For example, the control module 202 may detect and identify misconfigurations when the actuators 104, 106 are switched, the actuators 108, 110 are switched, the actuators 106, 110 are switched, the actuators 104, 110 are switched, and the actuators 106, 108 are switched.

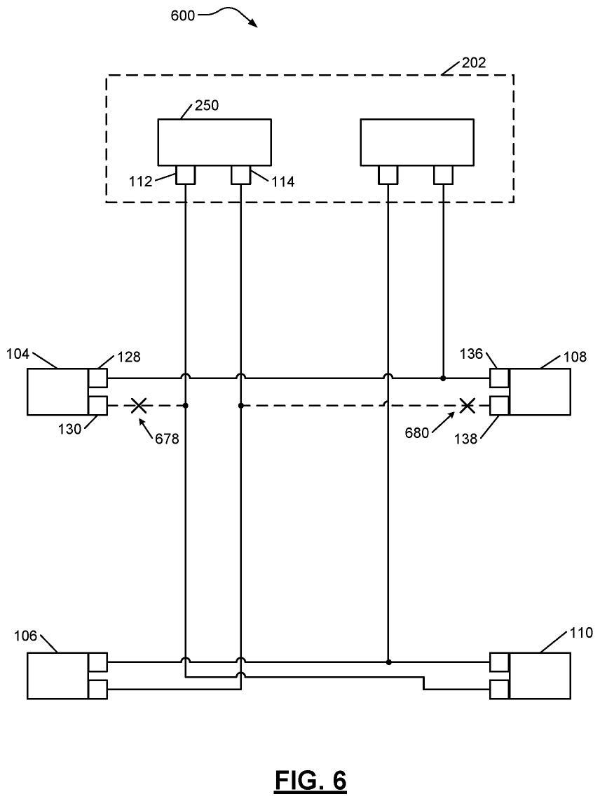

The control modules 102, 202 may also detect and identify a loss of communication and/or a loss of power with respect to one or more of the actuators 104, 106, 108, 110. For example, FIG. 6 depicts a system 600 substantially similar to the system 200 of FIG. 2, but with the interface port 130 of the actuator 104 and the interface port 138 of the actuator 108 experiencing a loss of communication with the control module 202 (as indicated by reference numbers 678, 680). In such examples, the control module 202 expects to receive data from the actuators 104, 108 at the interface ports 112, 114 of the aggregator module 250. If communication is lost with respect to the ports 130, 138, the aggregator module 250 may not receive any data with respect to the ports 130, 138, may receive a diagnostic trouble code (DTC), etc. In turn, the control module 202 recognizes the loss of communication for the ports 130, 138 the actuators 104, 108 as the reason for a system failure.

Although the system 600 of FIG. 6 is shown and described as having a loss of communication with respect to the interface ports 130, 138 of the actuators 104, 108, it should be appreciated that other interface ports (e.g., the interface ports 128, 136) of the actuators 104, 108 and/or interface ports of the actuators 106, 110 may experience a loss of communication. Additionally, while the system 600 includes two interface ports experiencing a loss of communication, it should be appreciated that only one interface port or more than two interface ports of the system 600 may experience a loss of communication. Regardless of the specific interface port(s) experiencing a loss of communication, the control module may detect and recognize the loss of communication for the specific interface port(s) in a similar manner as explained above.

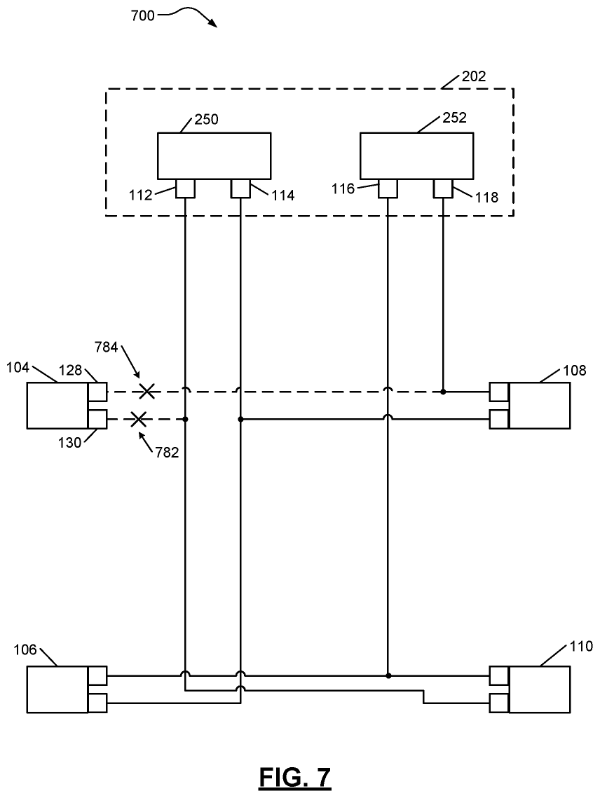

FIG. 7 depicts a system 700 substantially similar to the system 200 of FIG. 2, but with the actuator 104 experiencing a loss of power (as indicated by reference numbers 782, 784). In such examples, the control module 202 expects to receive data from the actuator 104 at the interface ports 112, 118 of the aggregator modules 250, 252. If power is lost at the actuator 104, the aggregator modules 250, 252 may not receive any data with respect to the ports 128, 130, may receive a DTC, etc. In turn, the control module 202 recognizes the loss of power for the actuator 104 as the reason for a system failure. The control module 202 may also recognize a loss of power with respect to the other actuators 106, 108, 110 in a similar manner.

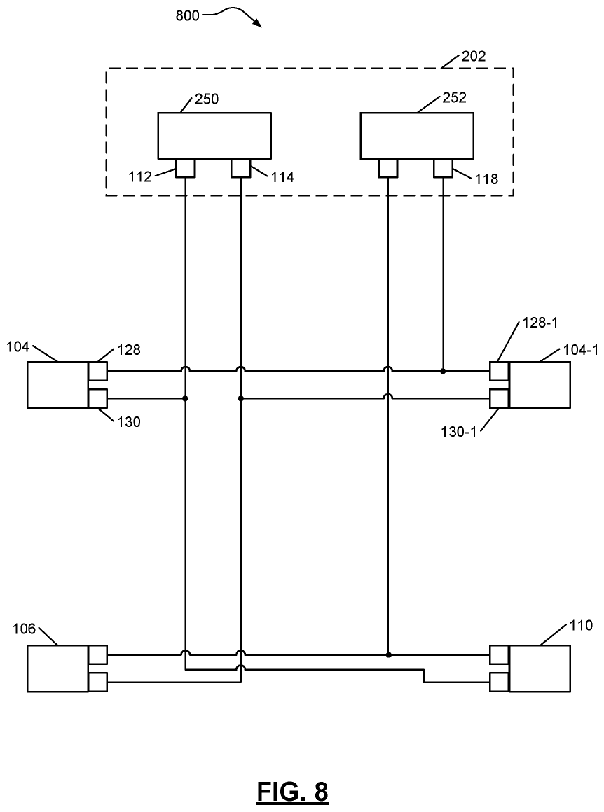

In various embodiments, the control module 102, 202 may also detect and identify an incorrect actuator being installed at a particular location. For example, FIG. 8 depicts a system 800 substantially similar to the system 200 of FIG. 2, but with one incorrectly installed actuator. Specifically, and as shown in FIG. 8, the system 800 includes the control module 202, the actuators 104, 108, 110, and an actuator 104-1. In the example of FIG. 8, the actuators 104, 108, 110 are correctly installed and the actuator 104-1 is incorrectly installed. In such examples, the actuator 104 is designated a front, left actuator (e.g., and installed at a front, left location of a vehicle) and assigned unique identifiers for that location (e.g., a MAC address of AA for the interface port 128 and a MAC address of EE for the interface port 130). Additionally, the actuator 106 may be designated a rear, left actuator and assigned unique identifiers for that location, while the actuator 110 may be designated a rear, right actuator and assigned unique identifiers for that location. In the example of FIG. 8, the actuator 104-1 is the same as the actuator 104, but installed at the front, right location of the vehicle. As such, the actuator 104-1 includes unique identifiers (e.g., a MAC address of AA for an interface port 128-1 and a MAC address of EE for an interface port 130-1) for a front, left location of the vehicle.

In such examples, the control module 202 receives the same unique identifiers (e.g., the MAC addresses AA, EE) from the actuators 104, 104-1. For instance, the control module 202 may expect to receive the MAC addresses AA, EE from the front, left actuator on the interface ports 118, 112 of the aggregator modules 252, 250 (respectively), and the MAC addresses BB, FF from the front, right actuator on the interface ports 118, 114 of the aggregator modules 252, 250 (respectively). However, in the example of FIG. 8, the control module 202 actually receives the MAC addresses AA, EE from both actuators 104, 104-1. As such, the control module 202 may detect the incorrect actuator being installed at the front, right location of the vehicle due to the interface port 114 of the aggregator module 250 receiving the MAC address EE instead of FF (as expected).

Further, in various embodiments, the control module 202 may receive and/or generate a DTC due to the incorrect actuator 104-1 being installed at the front, right location. For example, because both actuators 104, 104-1 are the same (physically and with respect to software installed therein), the actuators 104, 104-1 have the same device ID which can be used to prioritize (e.g., order) communication within the serial data link (e.g., network) associated with the interface port 118 of the aggregator module 252 and the actuators 104, 104-1. As such, because both actuators 104, 104-1 have the same device ID, the actuators 104, 104-1 may attempt to communicate with the aggregator module 252 at the same time. This may result in a DTC indicating a possible collision on the interface port 118 of the aggregator module 252.

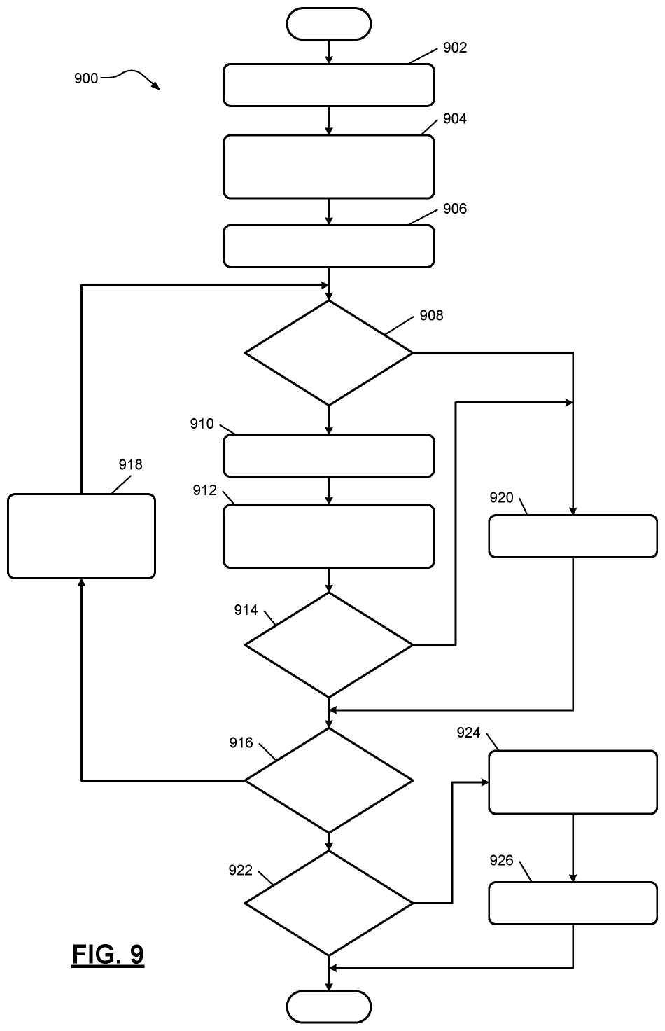

FIG. 9 illustrates an example control process 900 employable by the system 300 of FIG. 3 for detecting an actuator misconfiguration in a vehicle. Although the example control process 900 is described in relation to the system 300 of FIG. 3, the process 900 may be employable by any suitable system, such as the systems 100, 200 of FIGS. 1-2. The control process 900 may start when the system is powered-on and/or at another suitable time.

As shown in FIG. 9, control begins at 902 where unique identifiers are stored in memory modules of actuators. For example, the unique identifiers, such as MAC addresses, IP addresses, SOME/IP addresses, etc., may be stored in the actuators 104, 106, 108, 110 (e.g., in the memory modules 370, 372, 374, 376) during manufacturing of the actuators. In such examples, the unique identifiers may be assigned to the actuators based on designated vehicle locations (e.g., intended locations in the vehicle). For instance, the actuator 104 may be designated as a front, left actuator, and assigned unique identifiers specific to the front, left of the vehicle.

Control then proceeds to 904, where identifiers specific to locations of the vehicle are stored in a memory module associated with the control module 202. For example, the control module 202 may store identifiers for actuators at different locations of the vehicle (e.g., a front, left actuator; a front, right actuator; rear left actuator; a rear, right actuator; etc.), as explained herein.

Control then proceeds to 906, where the control module 202 initiates communication with one or more of the installed actuators 104, 106, 108, 110. For example, the aggregator modules 250, 252 may initially transmit beacons to the actuators 104, 106, 108, 110 and then wait for responses from the actuators 104, 106, 108, 110. As one example, the aggregator module 250 may transmit a beacon from the interface port 112 to the actuators 104, 110 (e.g., to the control modules 360, 366). Then, the actuators 104, 110 may respond with messages including, for example, their unique identifiers.

Control then proceeds to 908, where the control module 202 determines whether any messages are received from the actuators. If yes, control proceeds to 910. Otherwise, control proceeds to 920. At 910, the control module 202 extracts the unique identifiers from the received messages. Control then proceeds to 912.

At 912, the control module 202 compares the extracted unique identifiers from the received messages to identifiers previously stored in its memory module. For example, the control module 202 may determine the location of the actuators associated with the received messages. In such examples, if the messages are received at the interface port 112 of the aggregator module 250, the control module 202 may determine the locations of the actuators because the control module 202 knows that the interface port 112 receives messages from the specific locations in the vehicle (e.g., a front, left location and a rear, right location). Then, the control module 202 may retrieve the identifiers associated with the determined locations from the memory module associated with the control module 202. Once retrieved, the control module 202 may compare the extracted unique identifiers from the received messages to the previously stored identifiers. Control then proceeds to 914.

At 914, the control module 202 determines whether the compared identifiers are different. If the compared identifiers are not different, control proceeds to 916. If, however, the compared identifiers are different, control proceeds to 920. At 920, the control module 202 identifies one or more reasons for failure for the installed actuator, as explained herein. For example, the control module 202 may identify a loss of communication and/or a loss of power with respect to one or more of the actuators 104, 106, 108, 110 if, for example, no message is received at 908. In other examples, the control module 202 may identify a hardware and/or physical misconfiguration with respect to one or more installed actuators based on the comparison between the extracted unique identifiers and the previously stored interferes. In still other examples, the control module 202 may identify a software misconfiguration specific to any one of the installed actuators, as explained herein. Control then proceeds to 916.

At 916, the control module 202 determines whether any additional actuators are installed. If so, control proceeds to 918 where the control module 202 initiates communication with the next installed actuator (or set of installed actuators) in a similar manner as explained above relative to 906. Control then returns to 908. If no additional actuators are installed, control proceeds to 922 as shown in FIG. 9.

At 922, the control module 202 determines whether any failure reason was identified for any of the installed actuators. If no, control may end as shown in FIG. 9. If yes, control proceeds to 924, where the control module 202 determines the system state based on all identified failure reasons. Control then proceeds to 926, where the control module 202 generates and transmits an error signal indicating a system failure based on the identified failure reasons. For example, the control module 202 may transmit the error signal indicating the reason for failure associated with one or more of the actuators 104, 106, 108, 110 to a device, such as a display device, thereby notifying technicians that the actuator(s) are misconfigured.

The actuator misconfiguration detection systems and methods herein achieve numerous benefits. For example, with the unique communication connections associated with actuators and one or more control modules, vehicles are ensured to have correct actuator placements before the vehicles are delivered to users, car dealerships, etc. For instance, if the actuators are installed incorrectly and/or have software misconfigurations, the control modules herein detect such issues unless unreasonable effects are undertaken to substantially modify the actuators, vehicle harnesses, etc. Additionally, the actuator misconfiguration detection systems and methods allow one part number to be applied to different corner actuators and avoids proliferation of hardware variants in the actuators. For instance, each of the actuators may be the same physically but have different assigned unique identifiers, thereby allowing the use of one part number. Further, the actuator misconfiguration detection systems and methods eliminate the need for mechanical connector keying, keying using unique pin hardware (e.g., specific voltage at a pin), or keyed mounting features (e.g., unique bolt spacing for each corner).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for detecting actuator misconfiguration in a vehicle, the system comprising:
a plurality of actuators, each actuator of the plurality of actuators assigned a unique identifier; and
a control module including a plurality of interface ports in communication with the plurality of actuators via serial data links, each interface port of the control module in communication with two of the plurality of actuators, each actuator of the plurality of actuators in communication with two of the interface ports, the control module configured to:
receive a message from an actuator of the plurality of actuators installed at a location of the vehicle, the message including the unique identifier assigned to the actuator;
compare the received unique identifier assigned to the actuator to a stored identifier specific to the location of the vehicle; and
in response to the received unique identifier being different than the stored identifier, transmit an error signal indicating a failure associated with the actuator.

2. The system of claim 1, wherein the control module is configured to:
identify a reason for the failure based on the received unique identifier and the stored identifier; and
transmit the error signal with the reason for the failure.

3. The system of claim 1, wherein:
the plurality of interface ports of the control module includes four interface ports; and
the plurality of actuators includes four actuators.

4. The system of claim 3, wherein each actuator of the plurality of actuators includes a first interface port in communication with one of the four interface ports and a second interface port in communication with another one of the four interface ports.

5. The system of claim 3, wherein:
the four actuators include a first actuator installed at a front, left location of the vehicle, a second actuator installed at a front, right location of the vehicle, a third actuator installed at a rear, left location of the vehicle, and a fourth actuator installed at a rear, right location of the vehicle; and
the four interface ports include a first interface port in communication with the first actuator and the fourth actuator, a second interface port in communication with the second actuator and the third actuator, a third interface port in communication with the third actuator and the fourth actuator, and a fourth interface port in communication with the first actuator and the second actuator.

6. The system of claim 5, wherein the four actuators are brake actuators.

7. The system of claim 6, wherein each brake actuator of the brake actuators includes a memory module configured to store, before the brake actuator is installed in the vehicle, information about the brake actuator and an expected location of the brake actuator in the vehicle.

8. The system of claim 1, wherein the serial data links include of ethernet links.

9. The system of claim 1, wherein the unique identifier assigned to each actuator is a predefined MAC address stored in a memory module associated with the actuator.

10. A system for detecting actuator misconfiguration in a vehicle, the system comprising:
a plurality of actuators, each actuator of the plurality of actuators assigned a unique identifier; and
a control module including a first aggregator module and a second aggregator module, the first aggregator module including a plurality of interface ports, each interface port of the first aggregator module in communication with two different actuators of the plurality of actuators via a serial data link, the second aggregator module including a plurality of interface ports, each interface port of the second aggregator module in communication with two different actuators of the plurality of actuators via a serial data link, the control module configured to:
receive, via the first aggregator module or the second aggregator module, a message from an actuator of the plurality of actuators installed at a location of the vehicle, the message including the unique identifier assigned to the actuator;
compare the received unique identifier assigned to the actuator to a stored identifier specific to the location of the vehicle; and
in response to the received unique identifier being different than the stored identifier, transmit an error signal indicating a failure associated with the actuator.

11. The system of claim 10, wherein the control module is configured to:
identify a reason for the failure based on the received unique identifier and the stored identifier; and
transmit the error signal with the reason for the failure.

12. The system of claim 10, wherein:
the plurality of interface ports of the first aggregator module includes two interface ports;
the plurality of interface ports of the second aggregator module includes two interface ports; and
the plurality of actuators includes four actuators.

13. The system of claim 12, wherein each actuator of the plurality of actuators includes a first interface port in communication with one of the two interface ports of the first aggregator module and a second interface port in communication with one of the two interface ports of the second aggregator module.

14. The system of claim 12, wherein:
the four actuators include a first actuator located in a front, left position of the vehicle, a second actuator located in a front, right position of the vehicle, a third actuator located in a rear, left position of the vehicle, and a fourth actuator located in a rear, right position of the vehicle;
the two interface ports of the first aggregator module include a first interface port in communication with the first actuator and the fourth actuator, and a second interface port in communication with the second actuator and the third actuator; and
the two interface ports of the second aggregator module include a first interface port in communication with the third actuator and the fourth actuator, and a second interface port in communication with the first actuator and the second actuator.

15. The system of claim 14, wherein the four actuators are brake actuators.

16. The system of claim 15, wherein each brake actuator of the brake actuators includes a memory module configured to store, before the brake actuator is installed in the vehicle, information about the brake actuator and an expected location of the brake actuator in the vehicle.

17. The system of claim 10, wherein the serial data link includes of an ethernet link.

18. The system of claim 10, wherein the unique identifier assigned to each actuator is a predefined MAC address stored in a memory module associated with the actuator.
